(19) United States
(12) Patent Application Publication
(10) Pub. No.: US 2026/0197262 A1
(43) Pub. Date: Jul. 9, 2026

(54) Synthetic monitoring based on a content-delivery-network

(71) Applicant: IORIVER LTD., Yahud (IL)

(72) Inventors: Michael Hakimi, Holon (IL); Arkadi Butman, Petah Tikva (IL); Alex Khazanovitch, Nesher (IL); Edward Tsinovoi, Yahud (IL)

(21) Appl. No.: 19/441,904

(22) Filed: Jan. 7, 2026

Related U.S. Application Data
(60) Provisional application No. 63/742,463, filed on Jan. 7, 2025.

(51) Int. Cl. H04L 43/0811; H04L 65/61; H04L 65/80

(52) U.S. Cl. CPC H04L 43/0811; H04L 65/61; H04L 65/80

(57) ABSTRACT

Disclosed are systems and methods for synthetic monitoring of an internet-based service using a content delivery network (CDN). A monitoring CDN is caused to measure the availability and performance of the internet-based service at one or more geographic locations by triggering the execution of custom code on an edge-compute platform of the monitoring CDN. Data provided by the measuring of the availability and performance of the internet-based service at the one or more geographic locations is obtained and output.

### CROSS-REFERENCE TO RELATED APPLICATIONS

This application claims priority to US Provisional Ser. No. 63/742,463, titled “Synthetic Monitoring Based on a Content Delivery Network”, filed Jan. 7, 2025, which is hereby incorporated by reference in its entirety.

### FIELD

The present disclosure relates generally to synthetic monitoring of internet-based services, and more specifically, to systems and methods for performing synthetic monitoring via Content Delivery Networks (CDNs).

### BACKGROUND

Improving or maintaining an adequate users'digital experience of an internet-based service, like a website or a web application, e.g., with respect to availability and performance, is highly desired. Two key methodologies are often used for monitoring the users'experience at different geolocations of the world: synthetic monitoring and Real User Monitoring (RUM).

RUM methodology records real users'interactions with the reviewed or measured internet-based service. However, RUM, for example, may require a large volume of real users, which may not be achievable in an early stage, or, on the other hand, may lead to information overload in the case of a large number of users. Furthermore, RUM data may be noisy since real users may experience, for example, bad internet connection or bad devices. Moreover, when referring to websites, service providers, which are not the owner of the website, such as content providers, may not use RUM methodology for monitoring the users'experience.

Synthetic monitoring simulates real-user interactions with the measured internet-based service, e.g., like bots connecting to a website. Synthetic monitoring requires a network of checkpoints (e.g., servers) spread out in the world or at least in geolocations of interest to achieve proper monitoring. Such a geographic coverage may pose a challenge. One solution is to use service providers like Catchpoint™ for performing synthetic monitoring, however it may come with a relatively high cost.

### SUMMARY

The present disclosure relates to systems and methods for synthetic monitoring. The disclosed systems and methods may be conducted in a variety of manners and configurations.

In accordance with aspects of the present disclosure, a computerized method for synthetic monitoring of an internet-based service is disclosed. The method includes causing a monitoring Content Delivery Network (CDN) to measure the availability and performance of the internet-based service at one or more geographic locations by triggering execution of a custom code on top of an edge-compute platform of the monitoring CDN, obtaining data provided by the measuring of the availability and performance of the internet-based service at the one or more geographic locations, and outputting the data.

In various embodiments of the computerized method, the monitoring CDN includes a Point Of Presence (POP) at each geographic location of the one or more geographic locations. Triggering the execution of the custom code on top of the edge-compute platform of the monitoring CDN may then include, for each geographic location of the one or more geographic locations, triggering the execution of the custom code at the POP of the monitoring CDN located in the respective geographic location.

In various embodiments of the computerized method, the monitoring CDN utilizes Anycast technology, the monitoring CDN is stacked with a triggering CDN, and the triggering CDN does not utilize Anycast technology.

In various embodiments of the computerized method, causing the monitoring CDN to measure the availability and performance of the internet-based service at the respective geographic location includes sending a request to a POP of the triggering CDN located in the respective geographic location, where the request is configured to cause the triggering of the execution of the custom code at the POP of the monitoring CDN located in the respective geographic location.

In various embodiments of the computerized method, the triggering of the execution of the custom code at the POP of the monitoring CDN located in the respective geographic location causes the generation of an external request via the POP of the monitoring CDN to fetch a Uniform Resource Locator (URL) of the internet-based service.

In various embodiments of the computerized method, the obtained data is with respect to a returned response to the external request.

In various embodiments of the computerized method, the obtained data includes data with respect to the performance of the external request.

In various embodiments of the computerized method, the internet-based service is provided via a Multi-CDN, the Multi-CDN including a plurality of service CDNs, different from the monitoring CDN.

In various embodiments of the computerized method, causing the monitoring CDN to measure the availability and performance of the internet-based service at the one or more geographic locations is performed further with respect to each service CDN of at least a portion of the plurality of the service CDNs.

In various embodiments of the computerized method, the method further includes calculating a recommendation with respect to traffic routing within the Multi-CDN based on the obtained data and outputting the recommendation.

In various embodiments of the computerized method, outputting the recommendation includes automatically applying the traffic routing recommendation to the Multi-CDN.

In various embodiments of the computerized method, the triggering of the execution of the custom code at the POP of the monitoring CDN located in the respective geographic location causes the generation of an external request via the POP of the monitoring CDN, directed to a selected service CDN of the plurality of service CDNs, to fetch a URL of the internet-based service.

In various embodiments of the computerized method, the external request is directed to the selected service CDN by overriding the Domain Name System (DNS) resolution.

In various embodiments of the computerized method, generating the external request includes establishing a Transport Layer Security (TLS) connection by overriding the Server Name Indication (SNI) header.

In various embodiments of the computerized method, overriding the SNI header includes using a dedicated domain.

In various embodiments of the computerized method, the method further includes causing the system to generate the custom code.

In various embodiments of the computerized method, the internet-based service is a website.

In various embodiments of the computerized method, the monitoring CDN includes a plurality of CDNs.

In various embodiments of the computerized method, causing the monitoring CDN to measure the availability and performance of the internet-based service at one or more geographic locations is performed repeatedly.

In accordance with aspects of the present disclosure, a system for synthetic monitoring of an internet-based service is disclosed. The system includes at least one hardware processor and at least one computer readable storage device storing instructions for execution by the at least one hardware processor. The instructions, when executed, cause the system to cause a monitoring Content Delivery Network (CDN) to measure the availability and performance of the internet-based service at one or more geographic locations by triggering execution of a custom code on top of an edge compute platform of the monitoring CDN, obtain data provided by the measuring of the availability and performance of the internet-based service at the one or more geographic locations and output the data.

In various embodiments of the system, the monitoring CDN includes a Point of Presence (POP) at each geographic location of the one or more geographic locations, where triggering the execution of the custom code on top of the edge-compute platform of the monitoring CDN includes, for each geographic location of the one or more geographic locations, triggering the execution of the custom code at the POP of the monitoring CDN located in the respective geographic location.

In various embodiments of the system, the monitoring CDN utilizes Anycast technology, the monitoring CDN is stacked with a triggering CDN, and the triggering CDN does not utilize Anycast technology.

In various embodiments of the system, causing the monitoring CDN to measure the availability and performance of the internet-based service at the respective geographic location includes sending a request to a POP of the triggering CDN located in the respective geographic location, where the request is configured to cause the triggering of the execution of the custom code at the POP of the monitoring CDN located in the respective geographic location.

In various embodiments of the system, the triggering of the execution of the custom code at the POP of the monitoring CDN located in the respective geographic location causes the generation of an external request via the POP of the monitoring CDN to fetch a Uniform Resource Locator (URL) of the internet-based service.

In various embodiments of the system, the obtained data is with respect to a returned response to the external request.

In various embodiments of the system, the obtained data includes data with respect to the performance of the external request.

In various embodiments of the system, the internet-based service is provided via a Multi-CDN, the Multi-CDN comprising a plurality of service CDNs, different from the monitoring CDN.

In various embodiments of the system, causing the monitoring CDN to measure the availability and performance of the internet-based service at the one or more geographic locations is performed further with respect to each service CDN of at least a portion of the plurality of the service CDNs.

In various embodiments of the system, the instructions, when executed, further cause the system to calculate a recommendation with respect to traffic routing within the Multi-CDN based on the obtained data and to output the recommendation.

In various embodiments of the system, outputting the recommendation includes automatically applying the traffic routing recommendation to the Multi-CDN.

In various embodiments of the system, the triggering of the execution of the custom code at the POP of the monitoring CDN located in the respective geographic location causes the generation of an external request via the POP of the monitoring CDN, directed to a selected service CDN of the plurality of service CDNs, to fetch a URL of the internet-based service.

In various embodiments of the system, the external request is directed to the selected service CDN by overriding the Domain Name System (DNS) resolution.

In various embodiments of the system, generating the external request includes establishing a Transport Layer Security (TLS) connection by overriding the Server Name Indication (SNI) header.

In various embodiments of the system, overriding the SNI header includes using a dedicated domain.

In various embodiments of the system, the instructions, when executed, further cause the system to generate the custom code.

In various embodiments of the system, the internet-based service is a website.

In various embodiments of the system, the monitoring CDN comprises a plurality of CDNs.

In various embodiments of the system, causing the monitoring CDN to measure the availability and performance of the internet-based service at one or more geographic locations is performed repeatedly.

### BRIEF DESCRIPTION OF THE DRAWINGS

The above and other aspects and features of the disclosure will become more apparent in view of the following detailed description when taken in conjunction with the accompanying drawings wherein like reference numerals identify similar or identical elements.

FIG. 1 is a diagram illustrating RUM and synthetic monitoring of an internet-based service according to prior art;

FIG. 2 is a diagram illustrating the performance of synthetic monitoring via a CDN by a system for synthetic monitoring, in accordance with aspects of the present disclosure;

FIG. 3 is a flow diagram of a method for synthetic monitoring via a CDN, in accordance with aspects of the present disclosure; and

FIG. 4 is a diagram illustrating the performance of synthetic monitoring via stacking of CDNs by the system for synthetic monitoring of FIG. 2, in accordance with aspects of the present disclosure.

It will be appreciated that for simplicity and clarity of illustration, elements shown in the figures have not necessarily been drawn to scale. For example, the dimensions and/or aspect ratio of some of the elements can be exaggerated relative to other elements for clarity. Further, where considered appropriate, reference numerals can be repeated among the figures to indicate corresponding or analogous elements throughout the serial views.

### DETAILED DESCRIPTION

The present disclosure relates to systems and methods for synthetic monitoring via a CDN. A CDN is a network of geographically distributed servers (e.g., edge servers) that brings web content closer to where end users are located, to ensure high availability, optimized performance, and low latency. Since CDNs are very well distributed, the disclosed synthetic monitoring provides highly accurate monitoring by increasing the coverage of the points of presence at which the monitoring or measuring is performed. The ability to test performance and availability while using CDNs coverage significantly improves the quality of the synthetic monitoring.

Recently, CDN providers have been introducing a new compute capability as part of their edge services. This new capability allows customers to execute their own custom code on the CDN servers. This edge computing technology and capabilities are leveraged, inter alia, by the disclosed systems and methods, to provide synthetic monitoring. The disclosed synthetic monitoring utilizes edge-computing technology provided by CDNs which allow executing measurements via the CDN by triggering custom code on top of the edge-compute platform.

Furthermore, performing synthetic monitoring by the disclosed systems and methods is relatively cheaper, e.g., with respect to dedicated service providers. Thus, the disclosed synthetic monitoring provides large coverage and high-quality monitoring at a relatively low cost.

Moreover, the disclosed synthetic monitoring may improve traffic routing within Multi-CDN environments. A Multi-CDN is the practice of employing a number of CDN providers simultaneously. This methodology augments the performance benefits of using a CDN while also ensuring redundancy and resilience and reducing costs. To implement a Multi-CDN, organizations can use traffic management tools or Multi-CDN switching solutions that distribute and route content across the various CDN providers.

In the following detailed description, specific details are set forth in order to provide a thorough understanding of the disclosure. However, it will be understood by those skilled in the art that the disclosure may be practiced without these specific details. In other instances, well-known methods, procedures, and components have not been described in detail so as not to obscure the present disclosure. Some features or elements described with respect to one system may be combined with features or elements described with respect to other systems. For the sake of clarity, discussion of same or similar features or elements may not be repeated.

Although the disclosure is not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although the disclosure is not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Although the disclosure is not limited in this regard, by using the term “or” when listing two or more items or options, it is meant that each item, and each plausible or feasible combination of the listed items including a combination of all listed items may be considered.

Cloud deployment as used herein may refer to deployment on a geographically distributed network of servers.

Unless explicitly stated, the methods described herein are not constrained to a particular order or sequence. Additionally, some of the described methods or elements thereof can occur or be performed simultaneously, at the same point in time, or concurrently.

Although the disclosure is not limited in this regard, by using the term “or” when listing two or more items or options, it is meant that each item, each plausible or feasible combination of the listed items including a combination of all listed items may be considered.

The terms “Edge Computing”, “Edge Compute” or “Edge Computing Technology” may be used interchangeably herein. These terms may relate to or include the ability to run custom code on edge servers or CDNs. Although the disclosure is not limited in this regard, the term “CDN” may also refer to the associated “CDN Provider” and vice versa, depending on context.

The term “geographic location” or “geolocation” may relate to a specific geographic area, such as a portion of a continent, a country, a district or a city and the terms “geographic location” and “geolocation” may be used interchangeably.

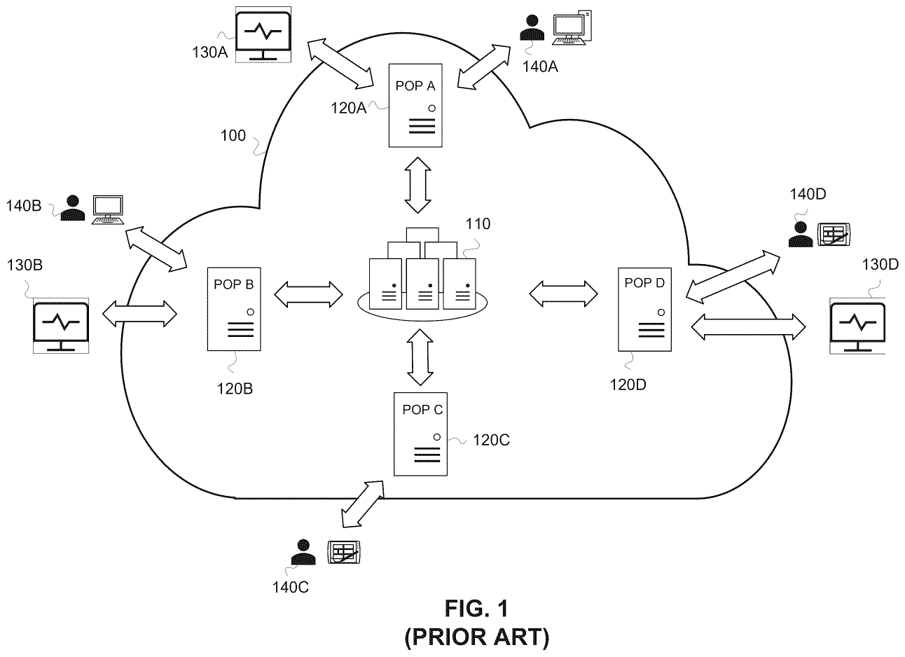

Reference is now made to FIG. 1, which is a diagram illustrating RUM and synthetic monitoring of an internet-based service according to prior art. The internet-based service is provided via origin or data center 110. In the specific example of FIG. 1, the internet-based service is provided via an exemplary CDN including POPs 120A-120D, each located in a different geographic location referenced correspondingly by A, B, C and D. RUM may be performed by monitoring real users'transactions with origin 110 via POPs 120A-120D such as users 140A-140D, respectively. Each user is located in the respective geographic location and would typically interact with origin 110 via the local POP or the nearest POP. A synthetic monitoring system may include POPs 130A, 130B and 130D located in geographic locations A, B and D, respectively. The synthetic monitoring system may provide synthetic monitoring, e.g., by using agents configured to access the internet-based service, replicating real users like users 140A-140D. However, the synthetic monitoring system may not perform measurements at geographic location C since the system does not include a POP in geographic location C.

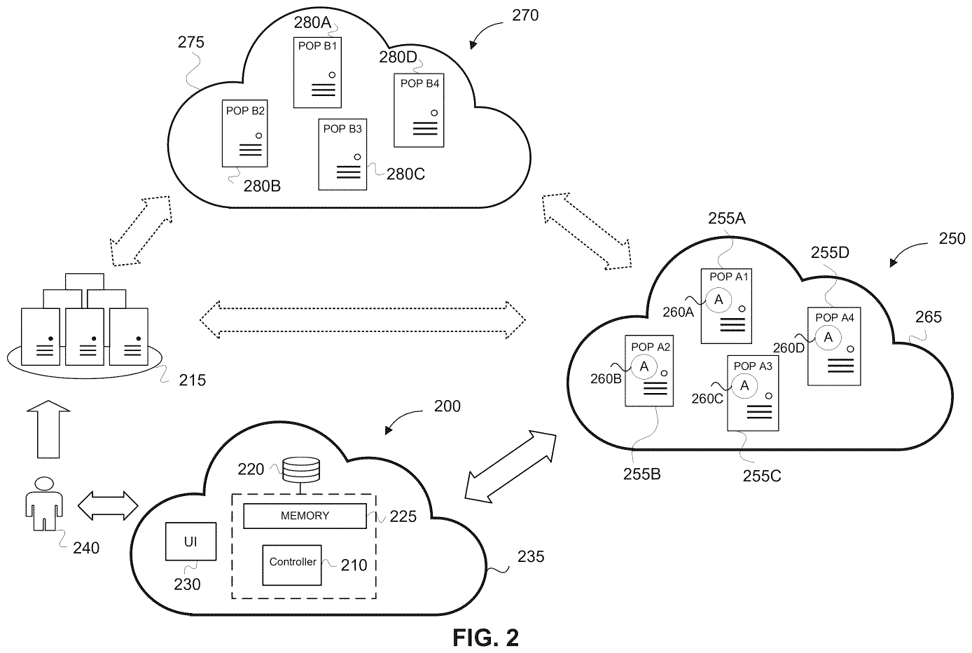

Reference is now made to FIG. 2, which is a diagram illustrating the performance of synthetic monitoring via a monitoring CDN 250 by a system for synthetic monitoring 200 (will also be referred herein as system 200) according to the present disclosure. An origin 215 may provide an internet-based service, such as a website, a web service, an API, Software As A Service (SaaS), online gaming, e-commerce and the like. According to some aspects, origin 215 may provide the internet-based service via a system 270. System 270 may be a CDN. System 270 may include a plurality of POPs, e.g., POPs 280A-280D, located in different geographic locations. System 270 may be deployed on a cloud (e.g., a cloud-platform) such as cloud 275 or be an on-premises system. Alternatively, origin 215 may not use a CDN for providing the internet-based service. According to some aspects, origin 215 may include servers located at a few different geographical locations. Origin 215 may be deployed, for example, on a cloud or on-premises.

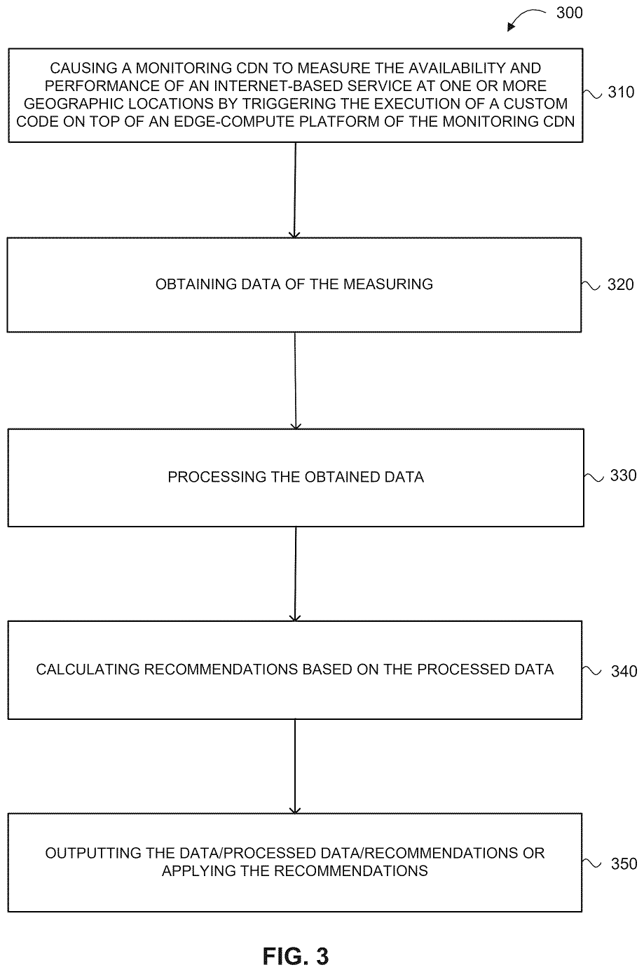

System 200 includes a controller (or a hardware processor) 210, a memory device (or memory) 225 and a storage device (or storage) 220. According to some aspects, system 200 may further include or provide a User Interface (UI) 230. System 200 may be deployed on a cloud platform 235. However, other configurations may be used. For example, system 200 may be deployed locally, e.g., on a one or more local servers. Storage 220 or memory 225 may include instructions (e.g., computer code or one or more applications) for execution by controller 210. According to some aspects, storage device 220 may be used to store results or data received with respect to synthetic monitoring performed by system 200 or such processed results or data. According to some aspects, the instructions stored by storage 220 or memory 225 may include code for processing the data received with respect to the disclosed synthetic monitoring to be executed by controller 210. Storage device 220 may be or may include one or more storage devices. Memory device 225 may be or may include one or more memory devices. UI 230 may include or may be a Graphical User Interface (GUI) configured to allow interaction of a user such as a user 240 with system 200. The instructions for generating or running UI 230 may be stored in storage 220 or memory 225 and executed by controller 210. Storage 220 or memory 225 may include instructions for executing a method for performing synthetic monitoring as disclosed with respect to FIG. 3 by controller 210.

User 240 may act for the provider of the internet-based service and may be, for example, a Development Operations (DevOps) professional or an automated tool, e.g., operated by a DevOps professional. User 240 may interact with system 200, e.g., via UI 230, with system 270 or with origin 215. According to some aspects, system 200 may be a system dedicated to performing synthetic monitoring according to the present disclosure. According to some aspects, system 200 may be a system employed by a provider of synthetic monitoring services according to the present disclosure providing synthetic monitoring, as disclosed to the provider of the internet-based service. According to some aspects, system 200 may be a system directly utilized by the provider of the internet-based service and, e.g., managed by user 240. According to some aspects, origin 215 may be included in system 200.

System 200 may employ CDN 250 as the monitoring CDN. Monitoring CDN 250 includes an edge-compute platform. Monitoring CDN 250 may include a plurality of POPs, e.g., POPs 255A-255D, also indicated as POPs A1-A4, respectively, located in different geographic locations. According to some aspects, agents 260A-260D may be generated on POPs A1-A4 respectively. Agents 260A-260D may be generated via the edge-compute platform of monitoring CDN 250. Agents 260A-260D may generate corresponding external requests to fetch a URL of an internet-based service. System 200 may trigger the execution of the custom code in one or more geographic locations, e.g., to generate respective agents 260A-260D on respective POPs A1-A4. For example, system 200 may trigger the execution of the custom code to generate agent 260A on POP A1 which is located in a specific geographic location. Agent 260A may then cause POP A1 to send an external request to fetch a URL, thereby simulating a user transaction with the internet-based service. If origin 215 employs a CDN such as system 270, then the external request would typically be directed to POP B1, which is the POP of system 270 that is located nearest (network latency-wise) to POP A1. POP B1 may then direct the external request to origin 215. Alternatively, if origin 215 does not utilize a CDN, then the external request would be directed to origin 215. System 200 may then collect or obtain data with respect to this transaction including, for example, the duration of time from the sending of the external request by POP A1 of CDN 250 until receipt of the response by POP A1. According to some aspects monitoring CDN 250 may include a plurality of CDNs (e.g., two or more CDNs) to improve geolocation coverage.

Reference is now made to FIG. 3, which is a flow diagram of a method 300 for synthetic monitoring via a CDN. Method 300 may be applied by a system for synthetic monitoring such as system 200 of FIG. 2. Method 300 is exemplified below via the specific layout of FIG. 2. At a step 310, a monitoring CDN is caused to measure the availability and performance of an internet-based service at one or more geographic locations by triggering execution of custom code on top of an edge-compute platform of the monitoring CDN, such as monitoring CDN 250. According to some aspects, the monitoring CDN may include a POP at each geographic location of geographic locations of interest, such as POPs A1-A4 of monitoring CDN 250. According to some aspects, the triggering of the execution of the custom code may include, for each geographic location, triggering the execution of the custom code at the POP of the monitoring CDN located in the geographic location. With reference to monitoring CDN 250, triggering (e.g., by system 200) the execution of the custom code deployed via the edge-compute platform of monitoring CDN 250 causes the generation of agents 260A-260D on POPs A1-A4 located in the geographic locations of interest, respectively. According to some aspects, the triggering of the execution of the custom code at the POP of the monitoring CDN may cause the generation of an external request via the POP to fetch a URL of the internet-based service. Referring to monitoring CDN 250 and system 200, the triggering of the custom code deployed on monitoring CDN 250, causes the generation of, e.g., agent 260A, which causes the sending of an external request to fetch a URL of the internet-based service by POP A1.

According to some aspects, the internet-based service may be considered unavailable when a timeout occurs or when a status code with an error is returned to the POP (e.g., via the agent) of the monitoring CDN in response to the generation of the external request. The generation of the external request or of a request as referred to herein includes its sending. Performance of the internet-based service may refer to or include various variables which may be measured and evaluated, including time to first byte (e.g., the time duration from sending the external request until receipt of the first byte of the response), time to last byte (e.g., the time duration from sending the external request until receipt of the last byte of the response), duration of time to establish connection, page load time and more. Such variables may be measured with respect to each generation of an external request and may be referred to, inter alia, as data relating to the performance of the external request.

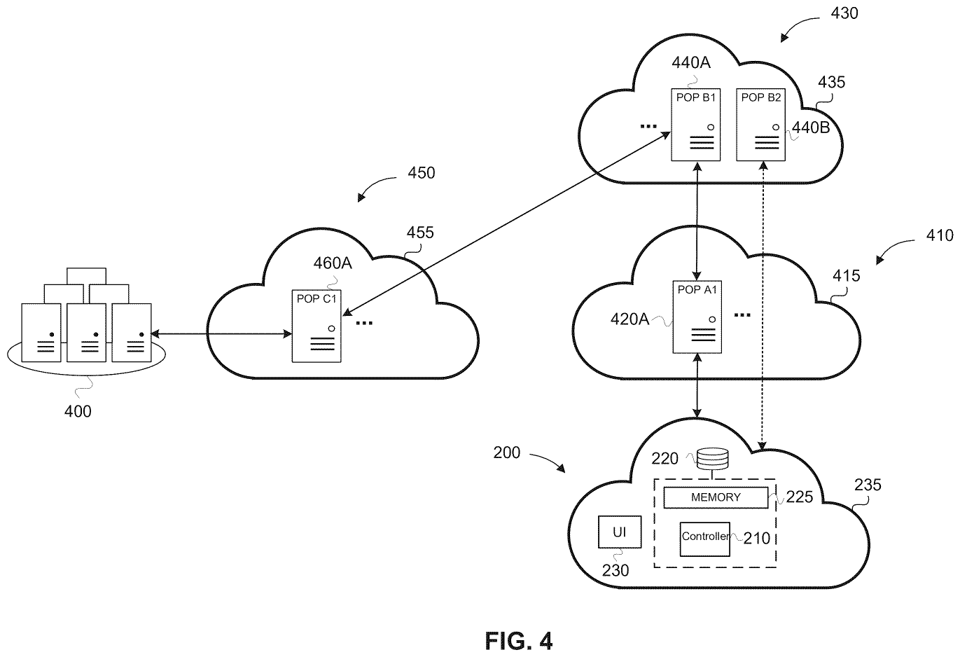

According to some aspects, triggering of the custom code may be performed by sending an HTTP request to a specific POP of the monitoring CDN located in this location. According to some aspects, the HTTP request may be sent directly to the POP's Internet Protocol (IP) address. According to some aspects, the IP address of a POP of a monitoring CDN in each geolocation may be discovered by using a one-time test via a synthetic monitoring service provider, by retrieving the IPs which responded. This may be performed if the monitoring CDN does not use Anycast technology for routing traffic. A configuration including a monitoring CDN which utilizes Anycast technology for routing traffic will be discussed herein below and with respect to FIG. 4.

According to some aspects, the monitoring CDN may utilize the Anycast technology for traffic routing. Utilizing Anycast technology may not allow sending the request directly to the POP of interest (e.g., the POP of the monitoring CDN located in a specific geographic location of interest). In such a case, the monitoring CDN may be stacked with a triggering CDN which does not utilize Anycast technology. Causing the monitoring CDN to measure the availability and performance of the internet-based service at a specific geographic location may then include sending a request to a POP of the triggering CDN located in the specific geographic location. The request may be configured to cause the triggering of the execution of the custom code at the POP of the monitoring CDN located in the geographic location. This may be performed, for example, by defining the monitoring CDN as the origin of the triggering CDN.

Reference is now made to FIG. 4, which is a diagram illustrating the performance of synthetic monitoring via stacking of CDNs 410 and 430 by system 200 of FIG. 2. System 200 may perform synthetic monitoring of an internet-based service provided by origin 400 according to the present disclosure. In this specific example, origin 400 utilizes a CDN 450 deployed on a cloud 455 for providing the internet-based service. CDN 450 may include a plurality of POPs (most of them not shown). The plurality of POPs includes a POP 460A also indicated as POP C1. System 200 may employ a CDN 430 deployed on a cloud 435 as the monitoring CDN. However, CDN 430 utilizes Anycast technology for traffic routing. CDN 430 may include a plurality of POPs located in different geographic locations, e.g., POPs 440A and 440B, also indicated as POPs B1 and B2, respectively. A measurement of the availability and performance of the internet-based service in a specific geographic location is desired. POP B1 of monitoring CDN 430 is located in the desired geographic location. POP B2 of monitoring CDN 430 is located in the geographic location of system 200. Since monitoring CDN 430 utilizes Anycast technology, triggering of the execution of the custom code may be directed to POP B2 of monitoring CDN 430 and not to POP B1. This may happen, for example, since POP B1 and POP B2 may have the same IP address. To overcome this issue, monitoring CDN 430 may be stacked with another CDN, CDN 410, which will be used as a triggering CDN. Triggering CDN 410 does not use Anycast technology for traffic routing. Triggering CDN 410 may include a plurality of POPs located at different geographic locations (most of them not shown). The plurality of POPs may include a POP 420A, also indicated as POP A1, located in the desired geographic location or is the POP of triggering CDN 410 which is nearest to the desired geographic location. Triggering CDN may be deployed on a cloud platform 415. System 200 may then send a request to POP A1 of triggering CDN 410 configured to cause the triggering of the execution of the custom code at POP B1 of monitoring CDN 430. The execution of the custom code on POP B1 may cause POP B1 to generate an external request to fetch a URL of the internet-based service, e.g., via POP C1 of CDN 450.

According to some aspects, the IP address of a POP of a monitoring CDN or of a triggering CDN in each geolocation, in case stacking of CDNs is used, may be discovered, e.g., by using a one-time test via a synthetic monitoring service provider. According to some aspects, a list of geographic locations and requests to a monitoring or a triggering CDN property may be generated. Once the test is completed, the IP address that responded at each geographic location may be extracted, and a geographic location to IP address mapping may be generated. If the IP addresses of the monitoring or triggering CDN occasionally change, the discovery procedure may be performed periodically, e.g., in an automatic manner.

It should be noted that a monitoring CDN should not be used to measure itself, since the results in this case would be extremely biased in favor of the monitoring CDN. Thus, the monitoring CDN has to be different from the one or more CDNs used by the origin of the internet-based service (in case such are used) to provide the internet-based service.

According to some aspects, the internet-based service may be provided via a Multi-CDN. A Multi-CDN may include a plurality of CDNs which will be referred to herein as service CDNs. According to some aspects, causing the monitoring CDN to measure the availability and performance of the internet-based service in one or more geographic locations may then be performed also with respect to each service CDN of at least a portion of the service CDNs of the Multi-CDN. Accordingly, the measurements of availability and performance of the internet-based service in a specific geolocation may be with respect to two or more or all service CDNs of the Multi-CDN. For example, one external request generated by the POP of the monitoring CDN located in the specific geolocation may be directed to a first service CDN and another external request generated by the POP of the monitoring CDN located in the specific geolocation may be directed to a second service CDN.

According to some aspects, in case a Multi-CDN is used for providing the internet-based service, the external request generated by the POPs of the monitoring CDN may be directed to a selected service CDN of the Multi-CDN by overriding the Domain Name System (DNS) resolution.

According to some aspects, generating the external request may include establishing a Transport Layer Security (TLS) connection by overriding the Server Name Indication (SNI) header. According to some aspects, overriding the SNI header may include using a dedicated domain. The dedicated domain points to the CDN Canonical Name (CNAME) and is included in the service CDN certificate domains.

At a step 320, data provided by the measuring of the availability and performance of the internet-based service at the one or more geographic locations may be obtained. The obtained data is with respect to a returned response to the external request generated by a POP of the monitoring CDN. The data may be obtained or collected by the disclosed systems, e.g., system 200 of FIG. 2, in various manners. According to some aspects, the data may be collected via the custom code, e.g., via the agents installed on top of the edge compute platform, as shown in FIG. 2.

According to some aspects, the obtained data may include the duration of time from the sending of the external request by a POP of the monitoring CDN until the receipt of the response by the POP of the monitoring CDN. The obtained data may include values of various parameters aimed at checking the availability and performance of the internet-based service in a specific geolocation and optionally via a specific CDN (in case a Multi-CDN is utilized to provide the internet-based service). According to some aspects, the obtained data may include values of various parameters aimed to check the availability and performance of the internet-based service from one or more various sources. According to some aspects, the sources may include geolocation (e.g., checking availability and performance from different geolocations), service CDN (e.g., checking availability and performance from different service CDNs, in case utilizing a Multi-CDN) and an Internet Service Provider (ISP; e.g., checking availability and performance from different ISPs).

According to some aspects, the obtained data may be processed at a step 330. The processing may be performed by the disclosed systems, such as system 200 of FIG. 2. The processing may include processing the measured parameters to evaluate the availability and performance of the internet-based service in the specific geolocation and optionally with respect to a specific service CDN or with respect to a specific ISP.

According to some aspects, and in case a Multi-CDN is employed to provide the internet-based service, decisions or recommendations may be calculated at a step 340 based on the obtained or processed data. Decisions or recommendations with respect to traffic routing within the Multi-CDN may be calculated based on the data obtained by the measurements. For example, availability and performance of two different service CDNs in a geolocation of interest may be measured. Based on the data provided by the performed measurements, a recommendation to change the routing of traffic in the geolocation from one service CDN to a second, better performing service CDN, may be calculated. Calculation of such recommendations may be performed repeatedly, e.g., once in a predefined time interval. According to some aspects, the recommendations with respect to traffic routing may be applied automatically. In such a configuration the recommendations are referred to as decisions.

At a step 350, the data, the processed data or the recommendations may be output. Referring to FIG. 2, the data, the processed data or the recommendations may be output to user 240 via UI 230 of system 200. The recommendations with respect to traffic routing may then be considered by the user or by an automatic tool to make traffic routing decisions. According to some aspects, the traffic routing recommendations may be automatically applied, e.g., as traffic routing decisions, e.g., via system 200.

According to some aspects, method 300 may further include generating the custom code. According to some aspects, method 300 may further include deploying the custom code on the edge-compute platform of the monitoring CDN. With reference to FIG. 2, the custom code may be generated and deployed by system 200 on the edge-compute platform of monitoring CDN 250. According to some aspects, the custom code may be executed on the edge-compute platform of monitoring CDN 250 via agents 260A-260D.

The measurements performed by the disclosed synthetic monitoring may be performed repeatedly, e.g., per a predefined time interval, to receive accurate monitoring of the availability and performance of the internet-based service.

The disclosed systems, such as system 200 of FIGS. 2 and 4, may include a controller or a hardware processor that may be or may include, for example, one or more central processing units (CPU), one or more Graphics Processing Units (GPU or GPGPU), and/or other types of hardware processor (or processor), such as a microprocessor, digital signal processor, microcontroller, programmable logic device (PLD), field programmable gate array (FPGA), or any suitable computing or computational device.

The disclosed systems, such as system 200 of FIGS. 2 and 4, may also include an operating system, a memory, such as memory 225, a storage device (also referred to herein as “storage”), such as storage device 220, input devices, output devices, or a communication device. The operating system may be or may include any code designed and/or configured to perform tasks involving coordination, scheduling, arbitration, supervising, controlling or otherwise managing operation of computing systems, such as scheduling execution of programs. The memory, such as memory 225, may be, or may include, for example, one or more Random Access Memory (RAM), read-only memory (ROM), flash memory, volatile memory, non-volatile memory, cache memory, and/or other memory devices. The storage, such as storage device 220, may store, for example, executable instructions that carry out an operation (e.g., executable code) and/or data. Executable code may be any executable code, e.g., an app/application, a program, a process, task, or script. Executable code may be executed by the controller of the disclosed systems, such as controller 210.

The storage, such as storage device 220, may be or may include, for example, one or more of a hard disk drive, a solid-state drive, an optical disc drive (such as DVD or Blu-Ray), a USB drive or other removable storage device, and/or other types of storage devices. Data such as instructions, code, procedure data, and the disclosed synthetic monitoring measurements data among other things, may be stored in the storage and may be loaded from the storage into a memory included in the storage where it may be processed by the controller, such as controller 210. The input devices may include, for example, a mouse, a keyboard, a touchscreen or pad, or another type of input device. The output devices may include one or more monitors, screens, displays, speakers and/or other types of output devices.

The illustrated components of the drawings are exemplary, and variations are contemplated to be within the scope of the present disclosure. For example, the numbers of components may be greater or fewer than as described and the types of components may be different than as described. For example, when the disclosed systems implement a server system, a large number of central processing units or cores may be utilized. As another example, the illustrated CDNs or server networks, such as CDN 250 and system 270 of FIG. 2 and CDNs 410, 430 and 450 of FIG. 4, would typically include a larger number of POPs than shown in the drawings. A further example refers to the illustrated clouds such as cloud 235, 265 and 275 of FIG. 2 and cloud 235, 415, 435 and 455 of FIG. 4. According to some aspects, although these clouds are illustrated as separate clouds, each two or more clouds may belong to the same cloud. In addition, further or alternative configurations may be used, such as an on-premises configuration. Other variations and applications are contemplated to be within the scope of the present disclosure. The aspects described above are exemplary and variations are contemplated to be within the scope of the present disclosure.

Accordingly, systems and methods for performing synthetic monitoring have been described herein. For purposes of explanation, specific configurations and details are set forth in order to provide a thorough understanding of aspects of the disclosed technology. However, it is apparent to one skilled in the art that the disclosed technology can be practiced without using every aspect presented herein.

Different aspects are disclosed herein. Features of certain aspects can be combined with features of other aspects; thus, certain aspects can be combinations of features of multiple aspects.

While several embodiments of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A computerized method for synthetic monitoring of an internet-based service, the method comprising:
causing a monitoring Content Delivery Network (CDN) to measure the availability and performance of the internet-based service at one or more geographic locations by triggering execution of a custom code on top of an edge-compute platform of the monitoring CDN;
obtaining data provided by the measuring of the availability and performance of the internet-based service at the one or more geographic locations; and
outputting the data.

2. The computerized method according to claim 1, wherein the monitoring CDN comprises a Point Of Presence (POP) at each geographic location of the one or more geographic locations, and wherein triggering the execution of the custom code on top of the edge-compute platform of the monitoring CDN comprises, for each geographic location of the one or more geographic locations, triggering the execution of the custom code at the POP of the monitoring CDN located in the respective geographic location.

3. The computerized method according to claim 2, wherein:
the monitoring CDN utilizes the Anycast technology,
the monitoring CDN is stacked with a triggering CDN, and the triggering CDN does not utilize the Anycast technology, and wherein causing the monitoring CDN to measure the availability and performance of the internet-based service at the respective geographic location comprises sending a request to a POP of the triggering CDN located in the respective geographic location, and wherein the request is configured to cause the triggering of the execution of the custom code at the POP of the monitoring CDN located in the respective geographic location.

4. The computerized method according to claim 2, wherein the triggering of the execution of the custom code at the POP of the monitoring CDN located in the respective geographic location causes the generation of an external request via the POP of the monitoring CDN to fetch a Uniform Resource Locator (URL) of the internet-based service.

5. The computerized method according to claim 4, wherein the obtained data is with respect to a returned response to the external request, and wherein the obtained data comprises data with respect to the performance of the external request.

6. The computerized method according to claim 2, wherein the internet-based service is provided via a Multi-CDN, the Multi-CDN comprising a plurality of service CDNs, different from the monitoring CDN.

7. The computerized method according to claim 6, wherein causing the monitoring CDN to measure the availability and performance of the internet-based service at the one or more geographic locations is further with respect to each service CDN of at least a portion of the plurality of the service CDNs.

8. The computerized method according to claim 2, wherein the triggering of the execution of the custom code at the POP of the monitoring CDN located in the respective geographic location causes the generation of an external request via the POP of the monitoring CDN, directed to a selected service CDN of the plurality of service CDNs, to fetch a URL of the internet-based service.

9. The computerized method according to claim 8, wherein the external request is directed to the selected service CDN by overriding the Domain Name System (DNS) resolution.

10. The computerized method according to claim 8, wherein generating the external request comprises establishing a Transport Layer Security (TLS) connection by overriding the Server Name Indication (SNI) header, and wherein overriding the SNI header comprises using a dedicated domain.

11. The computerized method of claim 1, wherein the monitoring CDN comprises a plurality of CDNs.

12. The computerized method of claim 1, wherein causing the monitoring CDN to measure the availability and performance of the internet-based service at one or more geographic locations is performed repeatedly.

13. A system for synthetic monitoring of an internet-based service, the system comprising:
at least one hardware processor;
at least one computer readable storage device storing instructions for execution by the at least one hardware processor, the instructions, when executed, cause the system to:
cause a monitoring Content Delivery Network (CDN) to measure the availability and performance of the internet-based service at one or more geographic locations by triggering execution of a custom code on top of an edge compute platform of the monitoring CDN;
obtain data provided by the measuring of the availability and performance of the internet-based service at the one or more geographic locations; and
output the data.

14. The system according to claim 13, wherein the monitoring CDN comprises a Point Of Presence (POP) at each geographic location of the one or more geographic locations, and wherein triggering the execution of the custom code on top of the edge-compute platform of the monitoring CDN comprises, for each geographic location of the one or more geographic locations, triggering the execution of the custom code at the POP of the monitoring CDN located in the respective geographic location.

15. The system according to claim 14, wherein:
the monitoring CDN utilizes the Anycast technology,
the monitoring CDN is stacked with a triggering CDN, and
the triggering CDN does not utilize the Anycast technology, and wherein causing the monitoring CDN to measure the availability and performance of the internet-based service at the respective geographic location comprises sending a request to a POP of the triggering CDN located in the respective geographic location, and wherein the request is configured to cause the triggering of the execution of the custom code at the POP of the monitoring CDN located in the respective geographic location.

16. The system according to claim 14, wherein the triggering of the execution of the custom code at the POP of the monitoring CDN located in the respective geographic location causes the generation of an external request via the POP of the monitoring CDN to fetch a Uniform Resource Locator (URL) of the internet-based service.

17. The system according to claim 16, wherein the obtained data is with respect to a returned response to the external request, and wherein the obtained data comprises data with respect to the performance of the external request.

18. The system according to claim 14, wherein the internet-based service is provided via a Multi-CDN, the Multi-CDN comprising a plurality of service CDNs, different than the monitoring CDN.

19. The system according to claim 18, wherein causing the monitoring CDN to measure the availability and performance of the internet-based service at the one or more geographic locations is performed further with respect to each service CDN of at least a portion of the plurality of the service CDNs.

20. The system according to claim 18, wherein the triggering of the execution of the custom code at the POP of the monitoring CDN located in the respective geographic location causes the generation of an external request via the POP of the monitoring CDN, directed to a selected service CDN of the plurality of service CDNs, to fetch a URL of the internet-based service.

21. The system according to claim 20, wherein the external request is directed to the selected service CDN by overriding the Domain Name System (DNS) resolution.

22. The system according to claim 20, wherein generating the external request comprises establishing a Transport Layer Security (TLS) connection by overriding the Server Name Indication (SNI) header, and wherein overriding the SNI header comprises using a dedicated domain.

23. The system of claim 13, wherein the monitoring CDN comprises a plurality of CDNs.

24. The system of claim 13, wherein causing the monitoring CDN to measure the availability and performance of the internet-based service at one or more geographic locations is performed repeatedly.
